(19) United States
(12) Patent Application Publication
(10) Pub. No.: US 2022/0390712 A1
(43) Pub. Date: Dec. 8, 2022

(54) Optical Imaging Camera Lens Assembly

(71) Applicant: ZHEJIANG SUNNY OPTICS CO.,LTD., Ningbo (CN)

(72) Inventors: Fujian DAI, Ningbo (CN); Xiaoting GENG, Ningbo (CN); Liefeng ZHAO, Ningbo (CN)

(21) Appl. No.: 17/829,399

(22) Filed: Jun. 1, 2022

(30) Foreign Application Priority Data
Jun. 3, 2021 (CN) 202110629127.X

(51) Int. Cl. G02B 9/64; G02B 1/04

(52) U.S. Cl. CPC G02B 9/64; G02B 1/041

(57) ABSTRACT

The disclosure provides an optical imaging camera lens assembly, sequentially including, from an object side to an image side along an optical axis: a first lens having a refractive power; a second lens having a positive refractive power; a third lens having a refractive power; a fourth lens having a negative refractive power; a fifth lens having a positive refractive power; a sixth lens having a refractive power; and a seventh lens having a refractive power. At least four lenses among the first lens to the fifth lens are lenses made of a plastic material; the sixth lens is a spherical lens made of a glass material; and a total effective focal length f of the optical imaging camera lens assembly and an entrance pupil diameter (EPD) of the optical imaging camera lens assembly satisfy: f/EPD<1.2.

### CROSS-REFERENCE TO RELATED PRESENT INVENTION(S)

The disclosure claims priority to and the benefit of Chinese Patent Present invention No. 202110629127.X, filed in the China National Intellectual Property Administration (CNIPA) on 3 Jun. 2021, which is incorporated herein by reference in its entirety.

### TECHNICAL FIELD

The disclosure relates to the technical field of optical elements, and in particular to an optical imaging camera lens assembly.

### BACKGROUND

With the development of video monitoring products toward a high-definition imaging direction, the video monitoring products have developed from initial 300,000 pixels to nearly 3 million pixels. The global video monitoring technology is ushering in a technological innovation. At the same time, as core components of video monitoring, monitoring lenses begin to enter a high-speed development stage.

At present, security and protection monitoring systems have been widely used in the monitoring of many public places such as road traffic, industry, production, hospitals, airports and libraries, wherein optical imaging camera lens assemblies play an important role in the security and protection monitoring systems. On the basis of the prior art, how to realize optical imaging camera lens assemblies with lower costs, higher pixels and other characteristics by reasonably matching key technical parameters such as refractive power and materials of various lenses in the optical imaging camera lens assemblies has become one of the difficulties to be solved urgently by numerous camera lens designers at present.

### SUMMARY

The disclosure provides such an optical imaging camera lens assembly. The optical imaging camera lens assembly sequentially includes, from an object side to an image side along an optical axis: a first lens having a refractive power; a second lens having a positive refractive power; a third lens having a refractive power; a fourth lens having a negative refractive power; a fifth lens having a positive refractive power; a sixth lens having a refractive power; and a seventh lens having a refractive power. At least four lenses among the first lens to the fifth lens are lenses made of a plastic material; the sixth lens is a spherical lens made of a glass material; and a total effective focal length f of the optical imaging camera lens assembly and an entrance pupil diameter (EPD) of the optical imaging camera lens assembly satisfy: f/EPD<1.2.

In one embodiment, at least one lens surface in an object-side surface of the first lens to an image-side surface of the seventh lens is an aspheric lens surface.

In one embodiment, an effective focal length f1 of the first lens and the total effective focal length f of the optical imaging camera lens assembly satisfy: −3.6<f1/f<−2.2.

In one embodiment, an effective focal length f4 of the fourth lens and an effective focal length f7 of the seventh lens satisfy: 0.4<f4/f7<1.7.

In one embodiment, an effective focal length f3 of the third lens, an effective focal length f5 of the fifth lens and an effective focal length f6 of the sixth lens satisfy: 0.2<(f5+f6)/f3<2.4.

In one embodiment, a curvature radius R1 of an object-side surface of the first lens, a curvature radius R2 of an image-side surface of the first lens, a curvature radius R3 of an object-side surface of the second lens and a curvature radius R4 of an image-side surface of the second lens satisfy: −0.7<(R1+R2)/(R3+R4)<−0.3.

In one embodiment, a curvature radius R7 of an object-side surface of the fourth lens and a curvature radius R8 of an image-side surface of the fourth lens satisfy: 1.7<R7/R8<2.8.

In one embodiment, a curvature radius R9 of an object-side surface of the fifth lens and a curvature radius R10 of an image-side surface of the fifth lens satisfy: 0<(R9+R10)/(R9−R10)<0.6.

In one embodiment, a combined focal length f67 of the sixth lens and the seventh lens, a curvature radius R11 of an object-side surface of the sixth lens, and a curvature radius R14 of an image-side surface of the seventh lens satisfy: 1.0<f67/(R11+R14)<4.5.

In one embodiment, a spacing distance T12 on the optical axis between the first lens and the second lens, a distance SAG11 on the optical axis from an intersection point of the object-side surface of the first lens and the optical axis to an effective radius vertex of the object-side surface of the first lens, and a distance SAG12 on the optical axis from the intersection point of the image-side surface of the first lens and the optical axis to the effective radius vertex of the image-side surface of the first lens satisfy: 0.8<T12/(SAG11+SAG12)<1.4.

In one embodiment, a center thickness CT2 of the second lens on the optical axis, a distance SAG21 on the optical axis from the intersection point of the object-side surface of the second lens and the optical axis to the effective radius vertex of the object-side surface of the second lens, and a distance SAG22 on the optical axis from the intersection point of the image-side surface of the second lens and the optical axis to the effective radius vertex of the image-side surface of the second lens satisfy: 2.9<CT2/(SAG21−SAG22)<6.0.

In one embodiment, an edge thickness ET4 of the fourth lens, an edge thickness ET5 of the fifth lens, an edge thickness ET6 of the sixth lens and an edge thickness ET7 of the seventh lens satisfy: 0.5<(ET4+ET5)/(ET6+ET7)<1.3.

In one embodiment, TTL is a distance on the optical axis from the object-side surface of the first lens to an imaging surface of the optical imaging camera lens assembly, and the total effective focal length f of the optical imaging camera lens assembly and TTL satisfy: 2.0<TTL/f<4.0.

In one embodiment, a sum ΣCT of the center thicknesses of the first lens to the seventh lens on the optical axis, and a sum ΣAT of the spacing distances on the optical axis of any two adjacent lenses among the first lens to the seventh lens satisfy: 2.6<ΣCT/ΣAT<4.2.

In one embodiment, the optical imaging camera lens assembly further includes a diaphragm. A distance SL on the optical axis from the diaphragm to the imaging surface of the optical imaging camera lens assembly, a center thickness CT3 of the third lens on the optical axis, a center thickness CT4 of the fourth lens on the optical axis, a center thickness CT5 of the fifth lens on the optical axis, a center thickness CT6 of the sixth lens on the optical axis, and a center thickness CT7 of the seventh lens on the optical axis satisfy: 1.2<SL/(CT3+CT4+CT5+CT6+CT7)<1.7.

Another embodiment of the disclosure provides such an optical imaging camera lens assembly. The optical imaging camera lens assembly sequentially includes, from an object side to an image side along an optical axis: a first lens having a refractive power; a second lens having a positive refractive power; a third lens having a refractive power; a fourth lens having a negative refractive power; a fifth lens having a positive refractive power; a sixth lens having a refractive power; and a seventh lens having a refractive power. At least four lenses among the first lens to the fifth lens are lenses made of a plastic material; the sixth lens is a spherical lens made of a glass material; and a combined focal length f67 of the sixth lens and the seventh lens, a curvature radius R11 of an object-side surface of the sixth lens, and a curvature radius R14 of an image-side surface of the seventh lens satisfy: 1.0<f67/(R11+R14)<4.5.

In one embodiment, an effective focal length f1 of the first lens and a total effective focal length f of the optical imaging camera lens assembly satisfy: −3.6<f1/f<−2.2.

In one embodiment, an effective focal length f4 of the fourth lens and an effective focal length f7 of the seventh lens satisfy: 0.4<f4/f7<1.7.

In one embodiment, an effective focal length f3 of the third lens, an effective focal length f5 of the fifth lens and the effective focal length f6 of the sixth lens satisfy: 0.2<(f5+f6)/f3<2.4.

In one embodiment, a curvature radius R1 of the object-side surface of the first lens, a curvature radius R2 of the image-side surface of the first lens, a curvature radius R3 of the object-side surface of the second lens and a curvature radius R4 of the image-side surface of the second lens satisfy: −0.7<(R1+R2)/(R3+R4)<−0.3.

In one embodiment, a curvature radius R7 of the object-side surface of the fourth lens and a curvature radius R8 of the image-side surface of the fourth lens satisfy: 1.7<R7/R8<2.8.

In one embodiment, a curvature radius R9 of the object-side surface of the fifth lens and a curvature radius R10 of the image-side surface of the fifth lens satisfy: 0<(R9+R10)/(R9−R10)<0.6.

In one embodiment, a spacing distance T12 on the optical axis between the first lens and the second lens, a distance SAG11 on the optical axis from an intersection point of the object-side surface of the first lens and the optical axis to an effective radius vertex of the object-side surface of the first lens, and a distance SAG12 on the optical axis from the intersection point of the image-side surface of the first lens and the optical axis to the effective radius vertex of the image-side surface of the first lens satisfy: 0.8<T12/(SAG11+SAG12)<1.4.

In one embodiment, a center thickness CT2 of the second lens on the optical axis, a distance SAG21 on the optical axis from the intersection point of the object-side surface of the second lens and the optical axis to the effective radius vertex of the object-side surface of the second lens, and a distance SAG22 on the optical axis from the intersection point of the image-side surface of the second lens and the optical axis to the effective radius vertex of the image-side surface of the second lens satisfy: 2.9<CT2/(SAG21−SAG22)<6.0.

In one embodiment, an edge thickness ET4 of the fourth lens, an edge thickness ET5 of the fifth lens, an edge thickness ET6 of the sixth lens and an edge thickness ET7 of the seventh lens satisfy: 0.5<(ET4+ET5)/(ET6+ET7)<1.3.

In one embodiment, TTL is a distance on the optical axis from the object-side surface of the first lens to an imaging surface of the optical imaging camera lens assembly, and the total effective focal length f of the optical imaging camera lens assembly and TTL satisfy: 2.0<TTL/f<4.0.

In one embodiment, a sum ΣCT of the center thicknesses on the optical axis of the first lens to the seventh lens, and a sum ΣAT of the spacing distances on the optical axis of any two adjacent lenses among the first lens to the seventh lens satisfy: 2.6<ΣCT/ΣAT<4.2.

In one embodiment, the optical imaging camera lens assembly further includes a diaphragm, and a distance SL on the optical axis from the diaphragm to the imaging surface of the optical imaging camera lens assembly, a center thickness CT3 of the third lens on the optical axis, a center thickness CT4 of the fourth lens on the optical axis, a center thickness CT5 of the fifth lens, a center thickness CT6 of the sixth lens on the optical axis, and a center thickness CT7 of the seventh lens on the optical axis satisfy: 1.2<SL/(CT3+CT4+CT5+CT6+CT7)<1.7.

In the disclosure, seven lenses are utilized, and by reasonably allocating the material, the focal length and the surface shape of each lens, the center thickness of each lens and the on-axis spacing between various lenses and the like, the optical imaging camera lens assembly has at least one beneficial effect of large aperture, high definition, low cost and high imaging quality, etc.

### BRIEF DESCRIPTION OF THE DRAWINGS

By reading detailed description of non-restrictive embodiments made with reference to the following drawings, other features, objectives and advantages of the disclosure will become more apparent:

FIG. 1 shows a schematic structural diagram of an optical imaging camera lens assembly according to Embodiment 1 of the disclosure;

FIG. 2A to FIG. 2D respectively show a longitudinal aberration curve, an astigmatism curve, a distortion curve and a lateral color curve of the optical imaging camera lens assembly in Embodiment 1;

FIG. 3 shows a schematic structural diagram of an optical imaging camera lens assembly according to Embodiment 2 of the disclosure;

FIG. 4A to FIG. 4D respectively show a longitudinal aberration curve, an astigmatism curve, a distortion curve and a lateral color curve of the optical imaging camera lens assembly in Embodiment 2;

FIG. 5 shows a schematic structural diagram of an optical imaging camera lens assembly according to Embodiment 3 of the disclosure;

FIG. 6A to FIG. 6D respectively show a longitudinal aberration curve, an astigmatism curve, a distortion curve and a lateral color curve of the optical imaging camera lens assembly in Embodiment 3;

FIG. 7 shows a schematic structural diagram of an optical imaging camera lens assembly according to Embodiment 4 of the disclosure;

FIG. 8A to FIG. 8D respectively show a longitudinal aberration curve, an astigmatism curve, a distortion curve and a lateral color curve of the optical imaging camera lens assembly in Embodiment 4;

FIG. 9 shows a schematic structural diagram of an optical imaging camera lens assembly according to Embodiment 5 of the disclosure; and

FIG. 10A to FIG. 10D respectively show a longitudinal aberration curve, an astigmatism curve, a distortion curve and a lateral color curve of the optical imaging camera lens assembly in Embodiment 5.

### DETAILED DESCRIPTION OF THE EMBODIMENTS

For a better understanding of the disclosure, various aspects of the disclosure will be illustrated in more detail with reference to the drawings. It should be understood that, these detailed illustrations are merely descriptions of exemplary embodiments of the disclosure, and are not intended to limit the scope of the disclosure in any way. Throughout the specification, the same reference signs refer to the same elements. The expression “and/or” includes any and all combinations of one or more of associated listed items.

It should be noted that in the present specification, the expressions of first, second, third and the like are only used for distinguishing one feature from another feature, but do not imply any limitation on the feature. Accordingly, without departing from the teachings of the disclosure, a first lens discussed below can also be referred to as a second lens or a third lens.

In the drawings, for the convenience of illustration, the thickness, size and shape of the lens have been slightly exaggerated. Specifically, spherical or aspheric shapes shown in the drawings are shown by way of examples. That is, the spherical or aspheric shapes are not limited to the spherical or aspheric shapes shown in the drawings. The drawings are examples only and are not drawn strictly to scale.

Herein, a paraxial region refers to a region in the vicinity of an optical axis. If a lens surface is a convex surface and the position of the convex surface is not defined, it means that the lens surface is a convex surface at least in the paraxial region; and if the lens surface is a concave surface and the position of the concave surface is not defined, it means that the lens surface is a concave surface at least in the paraxial region. A surface of each lens closest to a photographed object is called an object-side surface of the lens, and a surface of each lens closest to an imaging surface is called an image-side surface of the lens.

It should also be further understood that, the terms “contain,” “containing,” “having,” “includes” and/or “including”, when used in the present specification, indicate the presence of stated features, elements and/or components, but do not preclude the presence or addition of one or more other features, elements, components, and/or combinations thereof. In addition, when a statement such as “at least one of” appears after a list of listed features, it modifies the entire listed feature and not an individual element in the list. In addition, when the embodiments of the disclosure are described, “may” is used for expressing “one or more embodiments of the disclosure”. Furthermore, the term “exemplary” is intended to refer to an example or illustration.

Unless otherwise defined, all terms (including technical and scientific terms) used herein have the same meaning as commonly understood by those of ordinary skill in the art to which the disclosure belongs. It should also be understood that, the terms (such as those defined in commonly used dictionaries) should be interpreted as having the same meanings as those in the context of a related art, and will not be interpreted in an idealized or overly formal sense, unless expressly so defined herein.

It should be noted that, if there is no conflict, embodiments in the disclosure and features in the embodiments can be combined with each other. Hereinafter, the disclosure will be described in detail with reference to the drawings and in conjunction with the embodiments.

The features, principles and other aspects of the disclosure will be described in detail below.

An optical imaging camera lens assembly according to an exemplary embodiment of the disclosure can include seven lenses having refractive powers, which are respectively a first lens, a second lens, a third lens, a fourth lens, a fifth lens, and a sixth lens and a seventh lens. The seven lenses are arranged in sequence from an object side to an image side along an optical axis. Any two adjacent lenses among the first lens to the seventh lens can have a spacing distance.

In an exemplary embodiment, the first lens can have a positive refractive power or a negative refractive power; the second lens can have a positive refractive power; the third lens can have a positive refractive power or a negative refractive power; the fourth lens can have a negative refractive power; the fifth lens can have a positive refractive power; the sixth lens can have a positive or a negative refractive power; and the seventh lens can have a positive or a negative refractive power. By reasonably setting the refractive power of the first lens to the seventh lens, it is conducive to reasonably allocating the refractive power of the lenses, thereby reducing the sensitivity of the lenses as much as possible, and improving the production yield of the camera lens.

In an exemplary embodiment, the optical imaging camera lens assembly according to the disclosure satisfy: f/EPD<1.2, wherein f is a total effective focal length of the optical imaging camera lens assembly, and EPD is an entrance pupil diameter of the optical imaging camera lens assembly. More specifically, f and EPD may further satisfy: f/EPD<1.1. Since f/EPD<1.2 is satisfied, it is conducive to enabling the camera lens to have the characteristics such as a large aperture.

In an exemplary embodiment, the optical imaging camera lens assembly according to the disclosure may satisfy: −3.6<f1/f<−2.2, wherein f1 is an effective focal length of the first lens, and f is the total effective focal length of the optical imaging camera lens assembly. More specifically, f1 and f may further satisfy: −3.6<f1/f<−2.3. Since −3.6<f1/f<−2.2 is satisfied, it is conducive to reasonably allocating the refractive power of the lenses, thereby not only avoiding problems such as increased sensitivity and reduced yield caused by the excessive concentration of the refractive power on the first lens, but also avoiding a series of problems such as increased sensitivity caused by the excessive concentration of the refractive power on the subsequent lenses.

In an exemplary embodiment, the optical imaging camera lens assembly according to the disclosure may satisfy: 0.4<f4/f7<1.7, wherein f4 is the effective focal length of the fourth lens, and f7 is the effective focal length of the seventh lens. Since 0.4<f4/f7<1.7 is satisfied, it is conducive to reasonably allocating the refractive power of the fourth lens and the seventh lens. At the same, since −3.6<f1/f<−2.2 is satisfied, it is conducive to reducing the sensitivity of the camera lens, especially the temperature sensitivity of the camera lens.

In an exemplary embodiment, the optical imaging camera lens assembly according to the disclosure satisfy: 0.2<(f5+f6)/f3<2.4, wherein f3 is the effective focal length of the third lens, f5 is the focal length of the fifth lens, and f6 is the effective focal length of the sixth lens. Since 0.2<(f5+f6)/f3<2.4 is satisfied, it is conducive to improving the sensitivity of the lenses and improving the yield of the camera lens.

In an exemplary embodiment, the optical imaging camera lens assembly according to the disclosure satisfy: −0.7<(R1+R2)/(R3+R4)<−0.3, wherein R1 is a curvature radius of an object-side surface of the first lens, R2 is the curvature radius of an image-side surface of the first lens, R3 is the curvature radius of the object-side surface of the second lens, and R4 is the curvature radius of the image-side surface of the second lens. Since −0.7<(R1+R2)/(R3+R4)<−0.3 is satisfied, it is not only possible to ensure that the first lens and the second lens have reasonable refractive power, so as to avoid the problem of excessively poor image quality of the camera lens, but it is also possible to improve the production manufacturability of the first lens and the second lens.

In an exemplary embodiment, the optical imaging camera lens assembly according to the disclosure may satisfy: 1.7<R7/R8<2.8, wherein R7 is the curvature radius of the object-side surface of the fourth lens, and R8 is the curvature radius of the image-side surface of the fourth lens. More specifically, R7 and R8 may further satisfy: 1.8<R7/R8<2.8. Since 1.7<R7/R8<2.8 is satisfied, it can be ensured that the fourth lens has certain refractive power, and meanwhile the fourth lens has better manufacturability to facilitate the processing and assembly of subsequent camera lenses.

In an exemplary embodiment, the optical imaging camera lens assembly according to the disclosure satisfy: 0<(R9+R10)/(R9−R10)<0.6, wherein R9 is the curvature radius of the object-side surface of the fifth lens, R10 is the curvature radius of the image-side surface of the fifth lens. More specifically, R9 and R10 may further satisfy: 0.1<(R9+R10)/(R9−R10)<0.5. Since 0<(R9+R10)/(R9−R10)<0.6 is satisfied, it is ensured that the fifth lens has the ability to condense light, and meanwhile, not only can the manufacturability of the fifth lens be guaranteed, but the sensitivity of the fifth lens can also be reduced.

In an exemplary embodiment, the optical imaging camera lens assembly according to the disclosure satisfy: 1.0<f67/(R11+R14)<4.5, wherein f67 is a combined focal length of the sixth lens and the seventh lens, R11 is the curvature radius of the object-side surface of the sixth lens, and R14 is the curvature radius of the image-side surface of the seventh lens. Since 1.0<f67/(R11+R14)<4.5 is satisfied, it is not only conducive to reasonably allocating the refractive power of the sixth lens and the seventh lens, but it is also conducive to reducing the overall sensitivity of the camera lens.

In an exemplary embodiment, the optical imaging camera lens assembly according to the disclosure satisfy: 0.8<T12/(SAG11+SAG12)<1.4, wherein T12 is a spacing distance on the optical axis between the first lens and the second lens, SAG11 is the distance on the optical axis from an intersection point of the object-side surface of the first lens and the optical axis to an effective radius vertex of the object-side surface of the first lens, and SAG12 is the distance on the optical axis from the intersection point of the image-side surface of the first lens and the optical axis to the effective radius vertex of the image-side surface of the first lens. More specifically, T12, SAG11 and SAG12 may further satisfy: 0.8<T12/(SAG11+SAG12)<1.3. Since 0.8<T12/(SAG11+SAG12)<1.4 is satisfied, it is not only possible to ensure relatively good image quality for the camera lens, but it is also possible to improve the overall manufacturability of the first lens as much as possible, so as to facilitate the mass production process of the subsequent camera lenses.

In an exemplary embodiment, the optical imaging camera lens assembly according to the disclosure satisfy: 2.9<CT2/(SAG21−SAG22)<6.0, wherein CT2 is a center thickness of the second lens on the optical axis, SAG21 is the distance on the optical axis from the intersection point of the object-side surface of the second lens and the optical axis to the effective radius vertex of the object-side surface of the second lens, and SAG22 is the distance on the optical axis from the intersection point of the image-side surface of the second lens and the optical axis to the effective radius vertex of the image-side surface of the second lens. Since 2.9<CT2/(SAG21−SAG22)<6.0 is satisfied, when the image quality of the camera lens is improved, it is also conducive to guaranteeing the overall manufacturability of the second lens.

In an exemplary embodiment, the optical imaging camera lens assembly according to the disclosure satisfy: 0.5<(ET4+ET5)/(ET6+ET7)<1.3, wherein ET4 is an edge thickness of the fourth lens, ET5 is the edge thickness of the fifth lens, ET6 is the edge thickness of the sixth lens, and ET7 is the edge thickness of the seventh lens. More specifically, ET4, ET5, ET6 and ET7 may further satisfy: 0.7<(ET4+ET5)/(ET6+ET7)<1.3. Since 0.5<(ET4+ET5)/(ET6+ET7)<1.3 is satisfied, it is not only conducive to improving the image quality of the camera lens while improving the relative illuminance of a peripheral view field of the camera lens, but it is also conducive to reducing the sensitivity of the subsequent four lenses (the fourth lens to the seventh lens), and it is also helpful to guaranteeing better manufacturability for the subsequent four lenses, so as to facilitate the subsequent processing of the camera lens.

In an exemplary embodiment, the optical imaging camera lens assembly according to the disclosure satisfy: 2.0<TTL/f<4.0, wherein TTL is the distance on the optical axis from the object-side surface of the first lens to the imaging surface of the optical imaging camera lens assembly, and f is the total effective focal length of the optical imaging camera lens assembly. More specifically, TTL and f may further satisfy: 3.5<TTL/f<3.9. Since 2.0<TTL/f<4.0 is satisfied, it is not only conducive to shortening the total length TTL of the camera lens, but it is also conducive to avoiding problems such as excessively poor comprehensive performance of the camera lens caused by an excessively small TTL/f ratio.

In an exemplary embodiment, the optical imaging camera lens assembly according to the disclosure satisfy: 2.6<ΣCT/ΣAT<4.2, wherein ΣCT is the sum of the center thicknesses on the optical axis of the first lens to the seventh lens, and the ΣAT is the sum of the spacing distances on the optical axis of any two adjacent lenses among the first lens to the seventh lens. More specifically, ΣCT and ΣAT may further satisfy: 2.8<ΣCT/ΣAT<4.1. Since 2.6<ΣCT/ΣAT<4.2 is satisfied, it is conducive to ensuring that the optical imaging camera lens assembly has better image quality, and meanwhile, an excessively large overall size of the camera lens can also be avoided, thereby being conducive to maintaining the characteristics of miniaturization of the camera lens.

In an exemplary embodiment, the optical imaging camera lens assembly according to the disclosure further includes a diaphragm arranged between the second lens and the third lens. In particular, the optical imaging camera lens assembly according to the disclosure satisfy: 1.2<SL/(CT3+CT4+CT5+CT6+CT7)<1.7, wherein SL is the distance on the optical axis from the diaphragm to the imaging surface of the optical imaging camera lens assembly, CT3 is the center thickness of the third lens on the optical axis, CT4 is the center thickness of the fourth lens on the optical axis, CT5 is the center thickness of the fifth lens on the optical axis, CT6 is the center thickness of the sixth lens on the optical axis, and CT7 is the center thickness of the seventh lens on the optical axis. More specifically, SL, CT3, CT4, CT5, CT6 and CT7 may further satisfy: 1.3<SL/(CT3+CT4+CT5+CT6+CT7)<1.6. Since 1.2<SL/(CT3+CT4+CT5-FCT6+CT7)<1.7 is satisfied, it is not only possible to improve the overall performance of the camera lens, but it is also possible to avoid the problem of an increased overall size of the camera lens caused by the excessively large thicknesses of the subsequent five lenses (the third lens to the seventh lens). At the same time, the problem of reduced manufacturability due to the excessively small thicknesses of the subsequent five lenses can also be avoided.

In an exemplary embodiment, at least four lenses among the first lens to the fifth lens can be lenses made of a plastic material. Due to the use of the lenses made of the plastic material, it is conducive to reducing the manufacturing cost of the camera lens. In an exemplary embodiment, the sixth lens can be a spherical lens made of a glass material, that is, the sixth lens can be a lens made of a glass material, and both the object-side surface and the image-side surface thereof can be aspheric surfaces. This setting of the sixth lens is beneficial to improving the imaging quality of the camera lens. By means of the mixed matching the plastic lenses and the glass lenses, the optical imaging camera lens assembly provided by the disclosure can improve the imaging quality of the camera lens and realize high-definition imaging on the basis of reducing the production cost.

In an exemplary embodiment, the optical imaging camera lens assembly according to the disclosure can further include an optical filter for correcting chromatic aberration and/or protective glass for protecting a photosensitive element that is located on the imaging surface. The disclosure proposes an optical imaging camera lens assembly with the characteristics of large aperture, low cost, large target surface, high imaging quality, etc. The optical imaging camera lens assembly according to the above-mentioned embodiments of the disclosure can employ multiple lenses, such as the above seven lenses. By reasonably allocating the refractive power and the surface shapes of the lenses, the center thicknesses of the lenses, the on-axis distances between the lenses, and the like, the incident light can be effectively converged, the overall optical length of the imaging camera lens can be reduced, and the machinability of the imaging camera lens can be improved, such that the optical imaging camera lens assembly is more conducive to production and processing.

In the embodiments of the disclosure, at least one of lens surfaces of the first lens to the fifth lens and the seventh lens is an aspheric lens surface, that is, at least one lens surface of the object-side surface of the first lens to the image-side surface of the fifth lens, and the object-side surface and the image-side surface of the seventh lens is an aspheric lens surface. An aspheric lens is characterized in that, from the center of the lens to the periphery of the lens, the curvature changes continuously. Unlike a spherical lens, which has a constant curvature from the center of the lens to the periphery of the lens, the aspheric lens has better curvature radius characteristics, and has the advantages of improving distorted optical aberration and astigmatic aberration. After the aspheric lens is used, the optical aberration that occurs during imaging can be eliminated as much as possible, thereby improving the imaging quality. Optionally, at least one of the object-side surface and the image-side surface of each of the first lens, the second lens, the third lens, the fourth lens, the fifth lens and the seventh lens is an aspheric lens surface. Optionally, the object-side surface and the image-side surface of each of the first lens, the second lens, the third lens, the fourth lens, the fifth lens and the seventh lens are both aspheric lens surfaces.

However, those skilled in the art should understand that, without departing from the technical solutions claimed by the disclosure, the number of lenses constituting the optical imaging camera lens assembly can be changed to obtain various results and advantages described in the present specification. For example, although seven lenses are described as an example in the embodiments, the optical imaging camera lens assembly is not limited to including seven lenses. As needed, the optical imaging camera lens assembly can also include other numbers of lenses.

The specific embodiments of the optical imaging camera lens assembly applicable to the above-mentioned embodiments will be further described below with reference to the drawings.

### Embodiment 1

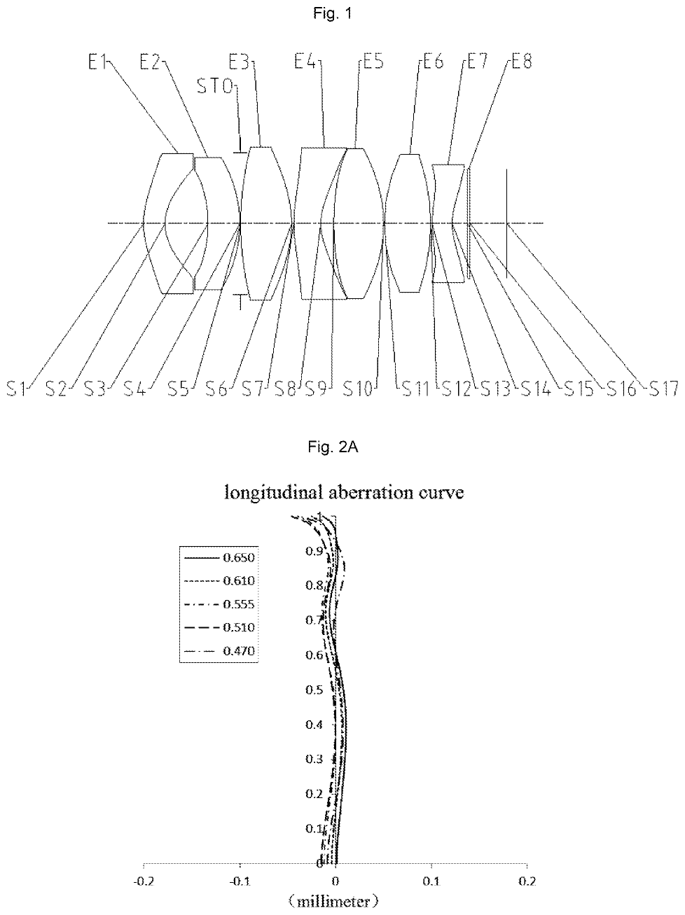

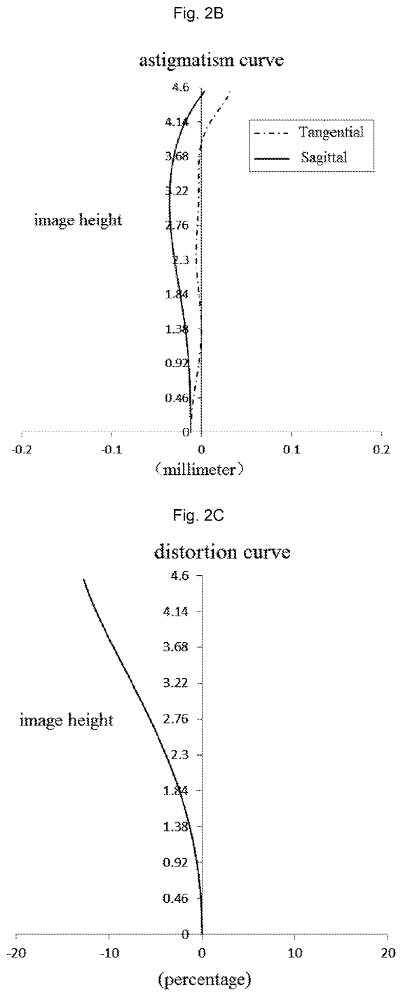

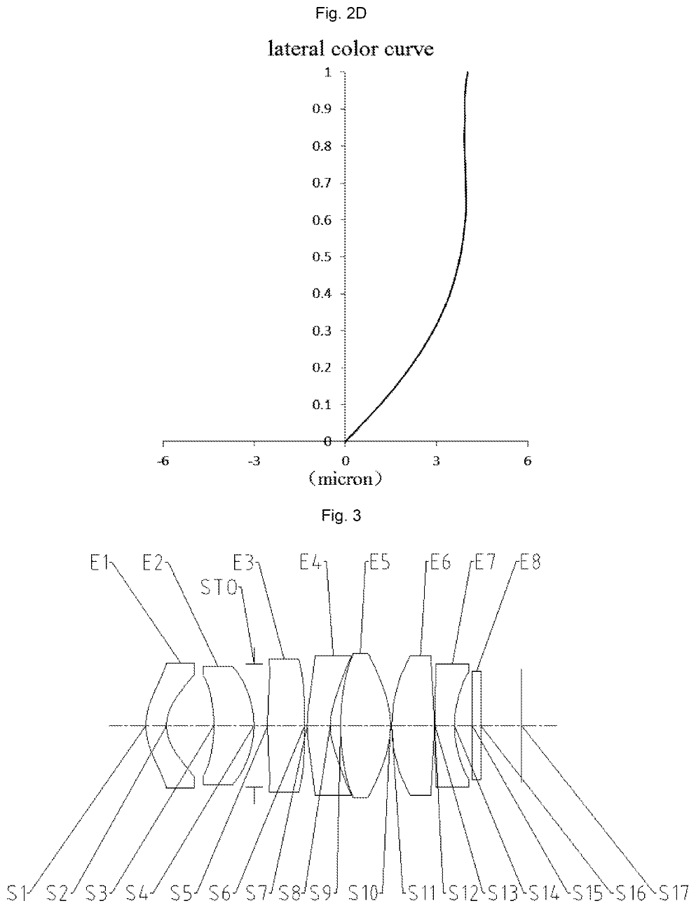

An optical imaging camera lens assembly according to Embodiment 1 of the disclosure will be described below with reference to FIG. 1 to FIG. 2D. FIG. 1 shows a schematic structural diagram of the optical imaging camera lens assembly according to Embodiment 1 of the disclosure.

As shown in FIG. 1, the optical imaging camera lens assembly sequentially includes, from an object side to an image side: a first lens E1, a second lens E2, a diaphragm ST0, a third lens E3, a fourth lens E4, a fifth lens E5, a sixth lens E6, a seventh lens E7, an optical filter E8 and an imaging surface S17.

The first lens E1 has a negative refractive power, an object-side surface S1 of which is a convex surface, and an image-side surface S2 of which is a concave surface. The second lens E2 has a positive refractive power, the object-side surface S3 of which is a concave surface, and the image-side surface S4 of which is a convex surface. The third lens E3 has a positive refractive power, the object-side surface S5 of which is a convex surface, and the image-side surface S6 of which is a convex surface. The fourth lens E4 has a negative refractive power, the object-side surface S7 of which is a convex surface, and the image-side surface S8 of which is a concave surface. The fifth lens E5 has a positive refractive power, the object-side surface S9 of which is a convex surface, and the image-side surface S10 of which is a convex surface. The sixth lens E6 has a positive refractive power, the object-side surface S11 of which is a convex surface, and the image-side surface S12 of which is a convex surface. The seventh lens E7 has a negative refractive power, the object-side surface S13 of which is a convex surface, and the image-side surface S14 of which is a concave surface. The optical filter E8 has an object-side surface S15 and an image-side surface S16. The light from an object sequentially passes through the surfaces S1 to S16 and is finally imaged on the imaging surface S17.

Table 1 shows a basic parameter table of the optical imaging camera lens assembly in Embodiment 1, wherein the units of curvature radius, thickness/distance and focal length are all millimeters (mm).

TABLE 1

| Surface | Surface | Curvature | Thickness/ | Refractive | Abbe | | Focal | Conic |
|---|---|---|---|---|---|---|---|---|
| number | type | radius | distance | index | number | Material | length | coefficient |
| OBJ | Spherical | Infinite | Infinite | | | | | |
| S1 | Aspheric | 6.8843 | 1.8000 | 1.55 | 56.1 | Plastic | −19.31 | −0.0465 |
| S2 | Aspheric | 3.7800 | 3.6035 | | | | | −1.0873 |
| S3 | Aspheric | −9.5468 | 2.6703 | 1.66 | 20.4 | Plastic | 89.96 | −1.5929 |
| S4 | Aspheric | −9.1547 | 0.0300 | | | | | −1.0111 |
| STO | Spherical | Infinite | 0.0300 | | | | | |
| S5 | Aspheric | 23.8054 | 4.2711 | 1.55 | 56.1 | Plastic | 12.10 | 0.0000 |
| S6 | Aspheric | −8.5630 | 0.1895 | | | | | −1.0000 |
| S7 | Aspheric | 11.5806 | 2.2483 | 1.66 | 20.4 | Plastic | −11.77 | 0.0000 |
| S8 | Aspheric | 4.3102 | 1.0938 | | | | | −1.0000 |
| S9 | Aspheric | 18.7777 | 4.1725 | 1.54 | 55.7 | Plastic | 14.31 | 1.2403 |
| S10 | Aspheric | −11.9905 | 0.0597 | | | | | 1.2409 |
| S11 | Spherical | 13.3771 | 3.8786 | 1.62 | 60.4 | Glass | 12.66 | |
| S12 | Spherical | −17.0417 | 0.1258 | | | | | |
| S13 | Aspheric | 9.0273 | 1.6755 | 1.67 | 19.2 | Plastic | −20.55 | 0.0000 |
| S14 | Aspheric | 5.0660 | 1.2865 | | | | | −1.0000 |
| S15 | Spherical | Infinite | 0.2100 | 1.52 | 64.2 | Glass | | |
| S16 | Spherical | Infinite | 3.0974 | | | | | |
| S17 | Spherical | Infinite | | | | | | |

In the present example, a total effective focal length f of the optical imaging camera lens assembly is 8.04 mm, TTL is a total length of the optical imaging camera lens assembly (that is, the distance on an optical axis from the object-side surface S1 of the first lens E1 to the imaging surface S17 of the optical imaging camera lens assembly), TTL is 30.44 mm, ImgH is a half of a diagonal length of an effective pixel region on the imaging surface S17 of the optical imaging camera lens assembly, ImgH is 4.55 mm, and FOV is a maximum field of view of the optical imaging camera lens assembly, FOV is 65.9°.

In Embodiment 1, the object-side surface and the image-side surface of any one of the first lens E1 to the fifth lens E5 and the seventh lens E7 are both aspheric surfaces, and the surface shape x of each aspheric lens can be defined, but not limited to, by the following aspheric formula:

$$x = \frac{{ch}^{2}}{1 + \sqrt{1 - ( k + 1 ) {c}^{2} {h}^{2}}} + \sum Ai {h}^{i} \qquad ( 1 )$$

wherein x is, when an aspheric surface is located at a position with a height h along the optical axis direction, a distance vector height from the vertex of the aspheric surface; c is a paraxial curvature of the aspheric surface, c=1/R (that is, the paraxial curvature c is a reciprocal of the curvature radius R in the above Table 1): k is a conic coefficient: and Ai is a correction coefficient of the i-th order of the aspheric surf ace. Table 2 below gives high-order coefficients A4, A6, A8, A10, A12, A14, A16, A18 and A20 that can be applied to various aspheric lens surfaces S1-S10, S13 and S14 in Embodiment 1.

TABLE 2

| Surface | | | | | | | | | |
|---|---|---|---|---|---|---|---|---|---|
| number | A4 | A6 | A8 | A10 | A12 | A14 | A16 | A18 | A20 |
| S1 | −1.4030E−03 | −3.0950E−05 | 2.7870E−06 | −1.8383E−07 | 9.6384E−09 | −3.1009E−10 | 5.3222E−12 | −3.7319E−14 | 0.0000E−00 |
| S2 | −6.8268E−04 | −2.9727E−05 | 9.7778E−07 | −1.8977E−08 | 7.8789E−09 | −7.1178E−10 | 2.7882E−11 | −5.1563E−13 | 3.8260E−15 |
| S3 | 5.0425E−04 | −3.1542E−05 | 1.9340E−06 | −3.8201E−07 | 2.8717E−08 | −1.1276E−09 | 1.6873E−11 | 0.0000E−00 | 0.0000E−00 |
| S4 | 4.0235E−04 | 4.5330E−06 | −1.4562E−06 | 8.8767E−08 | −4.1159E−09 | −1.1158E−10 | −1.3956E−12 | 5.7453E−15 | 0.0000E−00 |
| S5 | −5.5905E−05 | −1.5988E−07 | 2.1834E−08 | −2.6909E−10 | 1.4025E−12 | −3.3379E−15 | 2.9038E−18 | 0.0000E−00 | 0.0000E−00 |
| S6 | 1.2122E−03 | 5.8741E−05 | 1.8552E−06 | −3.2890E−10 | 3.1983E−10 | −1.6021E−12 | 3.2369E−15 | 0.0000E−00 | 0.0000E−00 |
| S7 | −2.0172E−03 | 1.1206E−04 | −6.1666E−06 | 2.2328E−07 | −4.8961E−09 | 6.4299E−11 | −4.9495E−13 | 2.0602E−15 | −3.5821E−18 |
| S8 | −5.8002E−03 | 4.0243E−04 | −2.4668E−05 | 1.1960E−06 | −4.3662E−08 | 1.1321E−09 | −1.9047E−11 | 1.8210E−13 | −7.4117E−16 |
| S9 | −5.4484E−04 | −1.7896E−06 | 4.8235E−06 | −3.6078E−07 | 1.2390E−08 | −2.1269E−10 | 1.4579E−12 | 3.1602E−15 | −6.4226E−17 |
| S10 | −1.9004E−04 | 9.9322E−06 | 1.5216E−06 | −1.5453E−07 | 7.4186E−09 | −2.0807E−10 | 3.4235E−12 | −3.0219E−14 | 1.0884E−16 |
| S13 | −3.6024E−03 | 8.7495E−06 | 7.855E−06 | −7.3591E−07 | 3.9254E−08 | −1.2973E−09 | 2.6816E−11 | −3.2918E−13 | 1.8790E−15 |
| S14 | −4.2892E−03 | 2.6428E−05 | 1.9463E−05 | −2.4931E−06 | 1.7975E−07 | −8.13391E−09 | 2.3375E−10 | −3.9250E−12 | 2.8981E−14 |

FIG. 2A shows a longitudinal aberration curve of the optical imaging camera lens assembly in Embodiment 1, which is the deviation of focus points of light with different wavelengths after passing through the camera lens. FIG. 28 shows an astigmatism curve of the optical imaging camera lens assembly in Embodiment 1, which is the curvature of a meridional image surface and, the curvature of a sagittal image surface. FIG. 2C shows a distortion curve of the optical imaging camera lens assembly in Embodiment 1, which is distortion size values corresponding to different image heights. FIG. 2D shows a lateral color curve of the optical imaging camera lens assembly in Embodiment 1, which is the deviation of different image heights on the imaging plane after the light passes through the camera lens. It can be seen according to FIG. 2A to FIG. 2D that, the optical imaging camera lens assembly provided in Embodiment 1 can realize good imaging quality.

### Embodiment 2

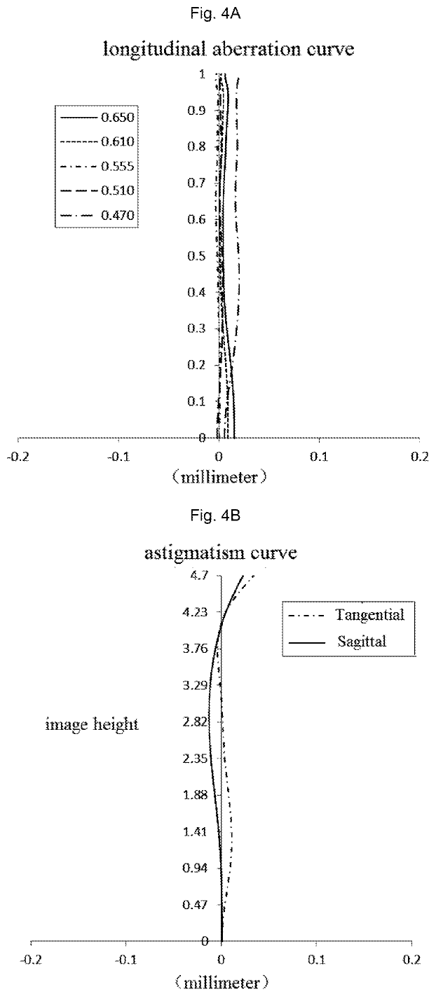

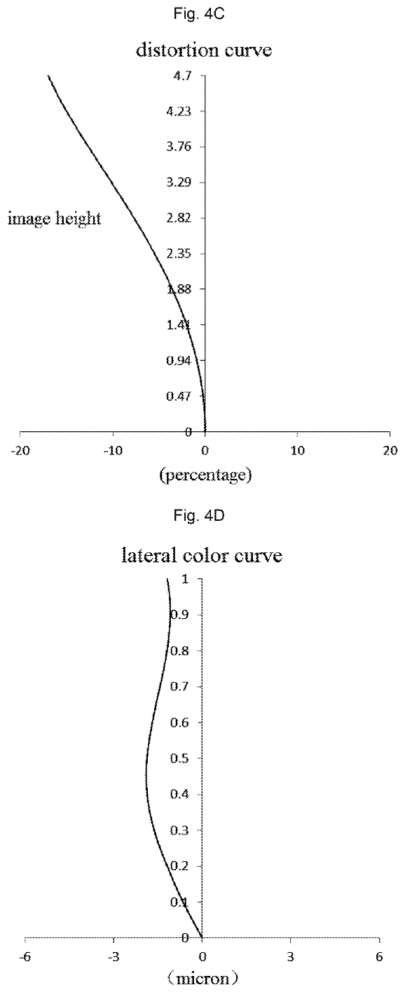

An optical imaging camera lens assembly according to Embodiment 2 of the disclosure will be described below with reference to FIG. 3 to FIG. 4D. In the present embodiment and the following embodiments, for the sake of brevity, some descriptions similar to those in Embodiment 1 will be omitted. FIG. 3 shows a schematic structural diagram of the optical imaging camera lens assembly according to Embodiment 2 of the disclosure.

As shown in FIG. 3, the optical imaging camera lens assembly sequentially includes, from an object side to an image side: a first lens E1, a second lens E2, a diaphragm ST0, a third lens E3, a fourth lens E4, a fifth lens E5, a sixth lens E6, a seventh lens E7, an optical filter E8 and an imaging surface S17.

The first lens E1 has a negative refractive power, an object-side surface S1 of which is a convex surface, and an image-side surface S2 of which is a concave surface. The second lens E2 has a positive refractive power, the object-side surface S3 of which is a concave surface, and the image-side surface S4 of which is a convex surface. The third lens E3 has a positive refractive power, the object-side surface S5 of which is a convex surface, and the image-side surface S6 of which is a convex surface. The fourth lens E4 has a negative refractive power, the object-side surface S7 of which is a convex surface, and the image-side surface S8 of which is a concave surface. The fifth lens E5 has a positive refractive power, the object-side surface S9 of which is a convex surface, and the image-side surface S10 of which is a convex surface. The sixth lens E6 has a positive refractive power, the object-side surface S11 of which is a convex surface, and the image-side surface S12 of which is a convex surface. The seventh lens E7 has a negative refractive power, the object-side surface S13 of which is a convex surface, and the image-side surface S14 of which is a concave surface. The optical filter E8 has an object-side surface S15 and an image-side surface S16. The light from an object sequentially passes through the surfaces S1 to S16 and is finally imaged on the imaging surface S17.

In the present example, a total effective focal length f of the optical imaging camera lens assembly is 8.57 mm, TTL is a total length of the optical imaging camera lens assembly, TTL is 31.00 mm, ImgH is a half of a diagonal length of an effective pixel region on the imaging surface S17 of the optical imaging camera lens assembly, ImgH is 4.70 mm, and FOV is a maximum field of view of the optical imaging camera lens assembly, FOV is 66.9°.

Table 3 shows a basic parameter table of the optical imaging camera lens assembly in Embodiment 2, wherein the units of curvature radius, thickness/distance and focal length are all millimeters (mm). Table 4 shows high-order coefficients that can be applied to various aspheric lens surfaces in Embodiment 2, wherein the aspheric surface shapes can be defined by the formula (1) given in the above Embodiment 1.

TABLE 3

| Surface | Surface | Curvature | Thickness/ | Refractive | Abbe | | Focal | Conic |
|---|---|---|---|---|---|---|---|---|
| number | type | radius | distance | index | number | Material | length | coefficient |
| OBJ | Spherical | Infinite | Infinite | | | | | |
| S1 | Aspheric | 5.0488 | 1.7000 | 1.55 | 56.1 | Plastic | −24.41 | −1.0000 |
| S2 | Aspheric | 3.2261 | 3.9110 | | | | | −1.0000 |
| S3 | Aspheric | −11.4133 | 3.3000 | 1.57 | 37.3 | Plastic | 24.74 | 0.0000 |
| S4 | Aspheric | −6.9722 | 0.0300 | | | | | 0.0000 |
| STO | Spherical | Infinite | 1.1132 | | | | | |
| S5 | Aspheric | 78.9332 | 3.0500 | 1.54 | 55.7 | Plastic | 52.99 | 23.3713 |
| S6 | Aspheric | −43.9242 | 0.2106 | | | | | 28.9234 |
| S7 | Aspheric | 9.7043 | 1.9000 | 1.66 | 20.4 | Plastic | −16.96 | 0.2656 |
| S8 | Aspheric | 4.8146 | 0.8559 | | | | | −0.8902 |
| S9 | Aspheric | 18.1254 | 4.1100 | 1.55 | 56.1 | Plastic | 10.54 | 0.0000 |
| S10 | Aspheric | −7.7541 | 0.0966 | | | | | 0.0000 |
| S11 | Spherical | 11.7353 | 3.5511 | 1.80 | 46.6 | Glass | 12.03 | |
| S12 | Spherical | −48.7017 | 0.0300 | | | | | |
| S13 | Aspheric | 50.2371 | 1.6000 | 1.67 | 19.2 | Plastic | −12.83 | 0.0000 |
| S14 | Aspheric | 7.3142 | 1.4770 | | | | | 0.0000 |
| S15 | Spherical | Infinite | 0.7000 | 1.52 | 64.2 | Glass | | |
| S16 | Spherical | Infinite | 3.3649 | | | | | |
| S17 | Spherical | Infinite | | | | | | |

TABLE 4

| Surface | | | | | | | | | |
|---|---|---|---|---|---|---|---|---|---|
| number | A4 | A6 | A8 | A10 | A12 | A14 | A16 | A18 | A20 |
| S1 | −8.0101E−04 | −4.0083E−05 | −5.4368E−07 | 1.1431E−07 | −3.4826E−09 | 4.2332E−11 | 2.9842E−14 | −3.6731E−15 | 0.0000E−00 |
| S2 | −4.3555E−04 | −1.0413E−04 | 7.8312E−07 | 1.8429E−07 | −6.0260E−09 | −1.3517E−11 | 2.7489E−12 | 0.0000E−00 | 0.0000E−00 |
| S3 | 5.0874E−04 | −2.9148E−05 | −2.9529E−06 | 2.5356E−07 | −1.5975E−08 | 4.0552E−10 | −1.3888E−12 | −1.2970E−14 | 0.0000E−00 |
| S4 | 1.6988E−03 | −1.3506E−04 | 7.2775E−06 | −2.7970E−07 | 6.3225E−09 | −5.2863E−11 | −3.6349E−13 | 1.5454E−14 | −2.5082E−16 |
| S5 | 1.7980E−03 | −2.3073E−04 | 1.5290E−05 | −7.4818E−07 | 2.4830E−08 | −4.6037E−10 | 3.5251E−12 | 0.0000E−00 | 0.0000E−00 |
| S6 | 6.2051E−03 | −7.3071E−05 | 4.8700E−06 | −3.0195E−07 | 1.2095E−08 | −2.4658E−10 | 1.9644E−12 | 0.0000E−00 | 0.0000E−00 |
| S7 | −3.2244E−03 | 1.4213E−04 | −1.3263E−06 | −3.4023E−07 | 2.3375E−08 | −7.0679E−10 | 1.0597E−11 | −6.4211E−14 | 0.0000E−00 |
| S8 | −5.4617E−03 | 3.3126E−04 | −1.5143E−06 | 4.9114E−07 | −1.2111E−08 | 2.3763E−10 | −3.0998E−12 | 1.8084E−14 | 0.0000E−00 |
| S9 | −2.9621E−04 | −1.4627E−05 | 4.7528E−06 | −3.1743E−07 | 9.5336E−09 | −1.2764E−10 | 4.9926E−13 | 1.8057E−15 | 0.0000E−00 |
| S10 | 7.6085E−04 | −5.3113E−06 | 3.9635E−07 | −1.6451E−07 | 3.7523E−10 | −2.8915E−12 | −1.2554E−14 | 2.2279E−16 | 0.0000E−00 |
| S13 | −9.7923E−04 | 5.8732E−03 | −2.8234E−06 | 1.1049E−07 | −2.6450E−09 | 3.1937E−11 | −1.4103E−13 | 0.0000E−00 | 0.0000E−00 |
| S14 | −2.2646E−03 | 1.1073E−04 | −2.3735E−06 | −9.4749E−08 | 1.3108E−08 | −4.0683E−10 | 1.2493E−12 | 1.1336E−13 | 0.0000E−00 |

FIG. 4A shows a longitudinal aberration curve of the optical imaging camera lens assembly in Embodiment 2, which is the deviation of focus points of light with different wavelengths after passing through the camera lens. FIG. 4B shows an astigmatism curve of the optical imaging camera lens assembly in Embodiment 2, which is the curvature of a meridional image surface and the curvature of a sagittal image surface. FIG. 4C shows a distortion curve of the optical imaging camera lens assembly in Embodiment 2, which is distortion size values corresponding to different image heights. FIG. 4D shows a lateral color curve of the optical imaging camera lens assembly in Embodiment 2, which is the deviation of different image heights on the imaging plane after the light passes through the camera lens. It can be seen according to FIG. 4A to FIG. 4D that, the optical imaging camera lens assembly provided in Embodiment 2 can realize good imaging quality.

### Embodiment 3

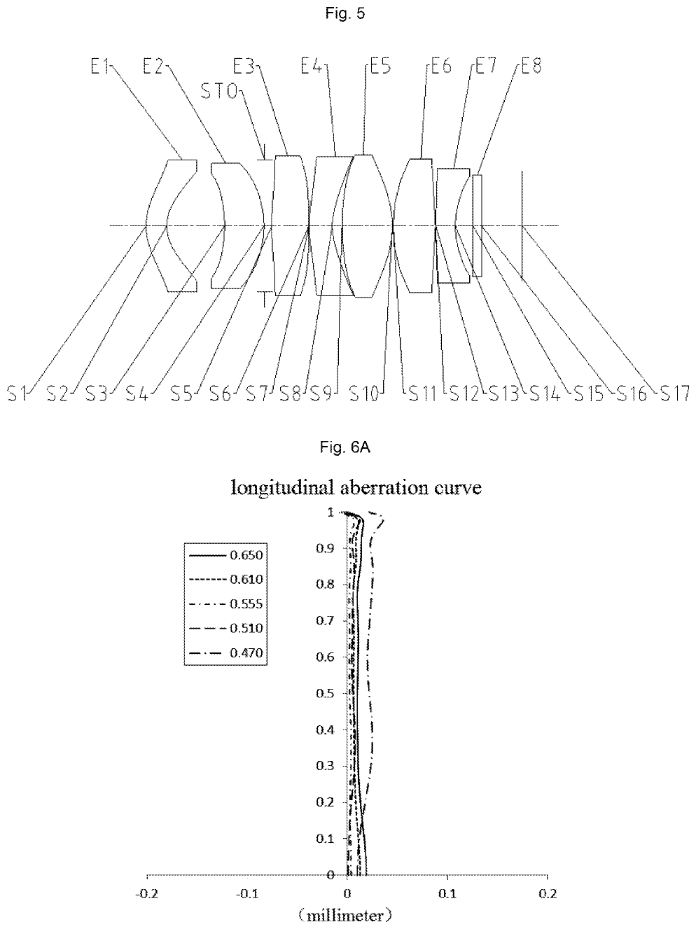

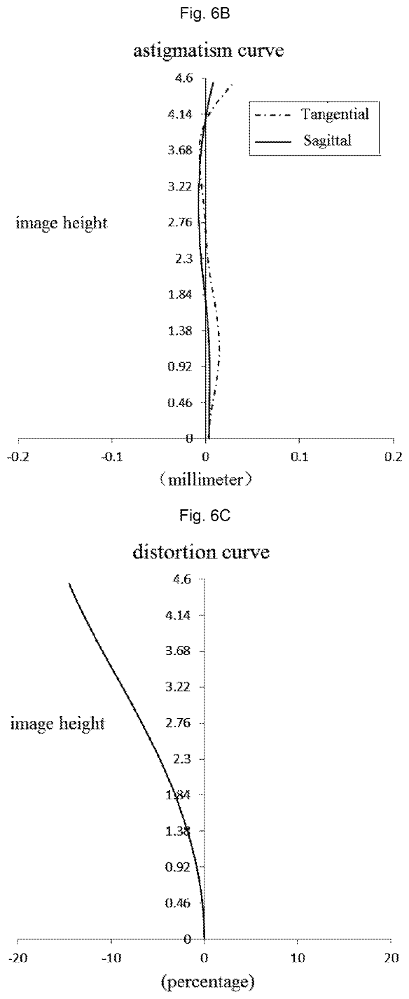

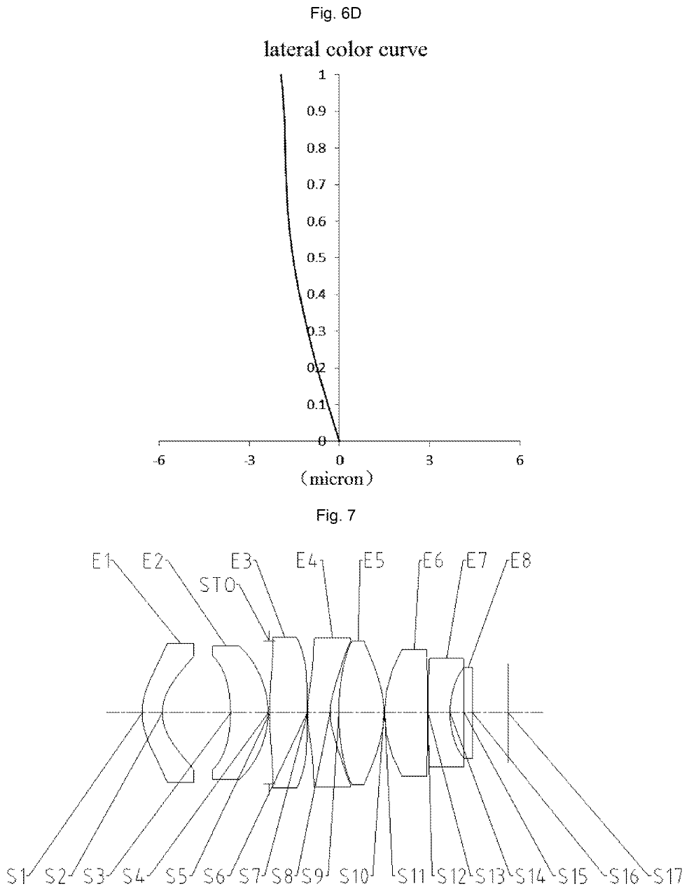

An optical imaging camera lens assembly according to Embodiment 3 of the disclosure will be described below with reference to FIG. 5 to FIG. 6D. FIG. 5 shows a schematic structural diagram of the optical imaging camera lens assembly according to Embodiment 3 of the disclosure.

As shown in FIG. 5, the optical imaging camera lens assembly sequentially includes, from an object side to an image side: a first lens E1, a second lens E2, a diaphragm ST0, a third lens E3, a fourth lens E4, a fifth lens E5, a sixth lens E6, a seventh lens E7, an optical filter E8 and an imaging surface S17.

The first lens E1 has a negative refractive power, an object-side surface S1 of which is a convex surface, and an image-side surface S2 of which is a concave surface. The second lens E2 has a positive refractive power, the object-side surface S3 of which is a concave surface, and the image-side surface S4 of which is a convex surface. The third lens E3 has a positive refractive power, the object-side surface S5 of which is a convex surface, and the image-side surface S6 of which is a convex surface. The fourth lens E4 has a negative refractive power, the object-side surface S7 of which is a convex surface, and the image-side surface S8 of which is a concave surface. The fifth lens E5 has a positive refractive power, the object-side surface S9 of which is a convex surface, and the image-side surface S10 of which is a convex surface. The sixth lens E6 has a positive refractive power, the object-side surface S11 of which is a convex surface, and the image-side surface S12 of which is a convex surface. The seventh lens E7 has a negative refractive power, the object-side surface S13 of which is a convex surface, and the image-side surface S14 of which is a concave surface. The optical filter E8 has an object-side surface S15 and an image-side surface S16. The light from an object sequentially passes through the surfaces S1 to S16 and is finally imaged on the imaging surface S17.

In the present example, a total effective focal length f of the optical imaging camera lens assembly is 8.68 mm, TTL is a total length of the optical imaging camera lens assembly, TTL is 31.00 mm, ImgH is a half of a diagonal length of an effective pixel region on the imaging surface S17 of the optical imaging camera lens assembly, ImgH is 4.55 mm, and FOV is a maximum field of view of the optical imaging camera lens assembly, FOV is 63.0°.

Table 5 shows a basic parameter table of the optical imaging camera lens assembly in Embodiment 3, wherein the units of curvature radius, thickness/distance and focal length are all millimeters (mm). Table 6 shows high-order coefficients that can be applied to various aspheric lens surfaces in Embodiment 3, wherein the aspheric surface shapes can be defined by the formula (1) given in the above Embodiment 1.

TABLE 5

| Surface | Surface | Curvature | Thickness/ | Refractive | Abbe | | Focal | Conic |
|---|---|---|---|---|---|---|---|---|
| number | type | radius | distance | index | number | Material | length | coefficient |
| OBJ | Spherical | Infinite | Infinite | | | | | |
| S1 | Aspheric | 5.1574 | 1.7000 | 1.55 | 56.1 | Plastic | −24.77 | −0.9944 |
| S2 | Aspheric | 3.2973 | 4.7677 | | | | | −0.9845 |
| S3 | Aspheric | −10.9781 | 3.2491 | 1.57 | 37.3 | Plastic | 26.18 | 0.3467 |
| S4 | Aspheric | −7.0071 | 0.0599 | | | | | 0.0007 |
| STO | Spherical | Infinite | 0.5833 | | | | | |
| S5 | Aspheric | 48.1656 | 3.0500 | 1.53 | 55.5 | Glass | 42.08 | 0.4111 |
| S6 | Aspheric | −41.3782 | 0.0300 | | | | | 38.9948 |
| S7 | Aspheric | 9.6685 | 1.9000 | 1.66 | 20.4 | Plastic | −17.07 | 0.1937 |
| S8 | Aspheric | 4.8178 | 0.8081 | | | | | −0.8895 |
| S9 | Aspheric | 17.2385 | 4.1385 | 1.55 | 56.1 | Plastic | 10.52 | −0.1157 |
| S10 | Aspheric | −7.8831 | 0.0600 | | | | | 0.0003 |
| S11 | Spherical | 11.8370 | 3.5010 | 1.74 | 44.9 | Glass | 12.83 | |
| S12 | Spherical | −43.9571 | 0.0300 | | | | | |
| S13 | Aspheric | 36.5496 | 1.6000 | 1.67 | 19.2 | Plastic | −11.90 | 0.0000 |
| S14 | Aspheric | 6.4907 | 1.4673 | | | | | 0.0000 |
| S15 | Spherical | Infinite | 0.7000 | 1.52 | 64.2 | Glass | | |
| S16 | Spherical | Infinite | 3.3552 | | | | | |
| S17 | Spherical | Infinite | | | | | | |

TABLE 6

| Surface | | | | | | | | | |
|---|---|---|---|---|---|---|---|---|---|
| number | A4 | A6 | A8 | A10 | A12 | A14 | A16 | A18 | A20 |
| S1 | −8.6487E−04 | −2.1420E−05 | −2.1443E−06 | 2.2429E−07 | −8.3077E−09 | 1.4142E−10 | 1.8816E−13 | −4.5847E−14 | 5.0667E−16 |
| S2 | −6.6451E−04 | −6.3191E−05 | −4.1696E−06 | 5.4689E−07 | −7.66202E−09 | −1.7420E−09 | 1.2751E−10 | −3.6377E−12 | 3.9100E−14 |
| S3 | 4.6619E−04 | −4.5618E−05 | 1.8678E−06 | −9.0089E−07 | 1.4910E−07 | −1.3633E−08 | 7.0350E−10 | −1.9023E−11 | 2.0959E−13 |
| S4 | 2.5437E−03 | −3.0383E−04 | 2.4081E−05 | −1.1055E−06 | −3.9458E−09 | 4.2311E−09 | −2.8153E−10 | 9.3125E−12 | −1.6108E−13 |
| S5 | 2.7101E−03 | −4.2170E−04 | 3.8094E−05 | −2.5599E−06 | 1.1877E−07 | −3.5194E−09 | 6.3201E−11 | −6.3178E−13 | 2.7414E−15 |
| S6 | 5.8656E−04 | −4.9745E−05 | 1.7842E−06 | −2.3469E−07 | 1.6566E−08 | −4.4573E−10 | 2.5380E−12 | 7.7300E−14 | −9.7060E−16 |
| S7 | −3.2931E−03 | 1.6928E−04 | −3.3619E−06 | −4.4127E−07 | 4.1447E−08 | −1.5937E−09 | 3.1847E−11 | −3.2181E−13 | 1.2871E−15 |
| S8 | −5.6827E−03 | 3.6938E−04 | −1.8565E−05 | 6.6745E−07 | −1.6340E−08 | 2.2331E−10 | 1.1244E−13 | −4.9011E−14 | 4.6419E−16 |
| S9 | −4.1301E−04 | −8.6093E−06 | 5.3898E−06 | −4.8449E−07 | 2.5199E−08 | −9.1811E−10 | 2.2553E−11 | −3.1809E−13 | 1.8764E−15 |
| S10 | 8.4876E−04 | −7.2528E−06 | 3.8526E−07 | −5.2317E−09 | −1.3937E−08 | 1.2120E−10 | −4.4628E−12 | 8.1078E−14 | −5.8957E−16 |
| S13 | −1.0199E−03 | 6.2424E−05 | −3.0625E−06 | 1.2231E−07 | −2.9880E−09 | 3.6820E−11 | −1.6593E−13 | 0.0000E−00 | 0.0000E−00 |
| S14 | −2.4290E−03 | 1.2300E−04 | −2.7305E−06 | −1.1289E−07 | 1.6174E−08 | −5.1989E−10 | 1.6533E−12 | 1.5538E−13 | 0.0000E−00 |

FIG. 6A shows a longitudinal aberration curve of the optical imaging camera lens assembly in Embodiment 3, which is the deviation of focus points of light with different wavelengths after passing through the camera lens. FIG. 6B shows an astigmatism curve of the optical imaging camera lens assembly in Embodiment 3, which is the curvature of a meridional image surface and the curvature of a sagittal image surface. FIG. 6C shows a distortion curve of the optical imaging camera lens assembly in Embodiment 3, which is distortion size values corresponding to different image heights. FIG. 6D shows a lateral color curve of the optical imaging camera lens assembly in Embodiment 3, which is the deviation of different image heights on the imaging plane after the light passes through the camera lens. It can be seen according to FIG. 6A to FIG. 6D that, the optical imaging camera lens assembly provided in Embodiment 3 can realize good imaging quality.

### Embodiment 4

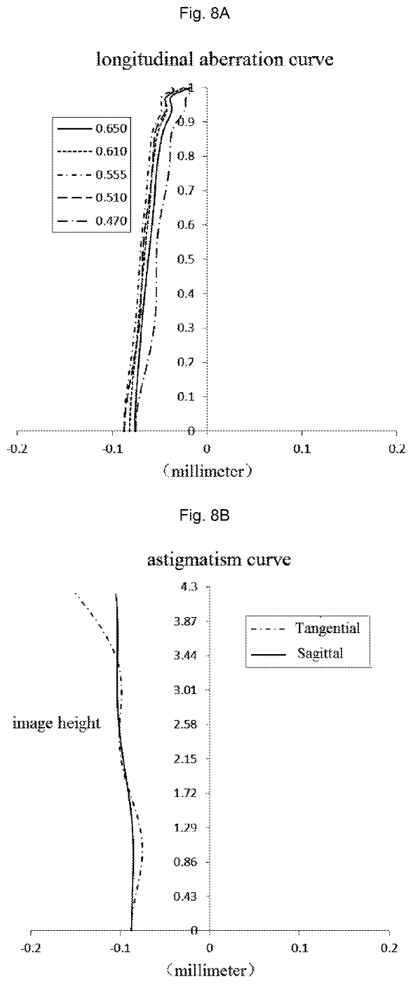

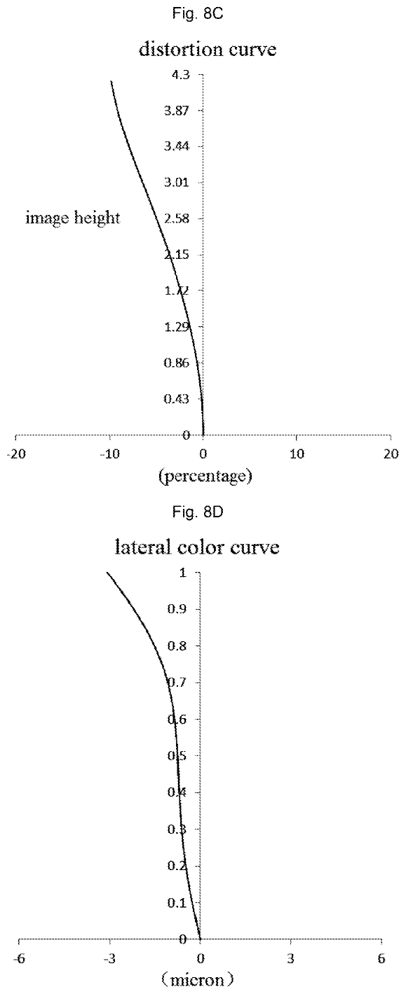

An optical imaging camera lens assembly according to Embodiment 4 of the disclosure will be described below with reference to FIG. 7 to FIG. 8D. FIG. 7 shows a schematic structural diagram of the optical imaging camera lens assembly according to Embodiment 4 of the disclosure.

As shown in FIG. 7, the optical imaging camera lens assembly sequentially includes, from an object side to an image side: a first lens E1, a second lens E2, a diaphragm ST0, a third lens E3, a fourth lens E4, a fifth lens E5, a sixth lens E6, a seventh lens E7, an optical filter E8 and an imaging surface S17.

The first lens E1 has a negative refractive power, an object-side surface S1 of which is a convex surface, and an image-side surface S2 of which is a concave surface. The second lens E2 has a positive refractive power, the object-side surface S3 of which is a concave surface, and the image-side surface S4 of which is a convex surface. The third lens E3 has a positive refractive power, the object-side surface S5 of which is a convex surface, and the image-side surface S6 of which is a convex surface. The fourth lens E4 has a negative refractive power, the object-side surface S7 of which is a convex surface, and the image-side surface S8 of which is a concave surface. The fifth lens E5 has a positive refractive power, the object-side surface S9 of which is a convex surface, and the image-side surface S10 of which is a convex surface. The sixth lens E6 has a positive refractive power, the object-side surface S11 of which is a convex surface, and the image-side surface S12 of which is a convex surface. The seventh lens E7 has a negative refractive power, the object-side surface S13 of which is a convex surface, and the image-side surface S14 of which is a concave surface. The optical filter E8 has an object-side surface S15 and an image-side surface S16. The light from an object sequentially passes through the surfaces S1 to S16 and is finally imaged on the imaging surface S17.

In the present example, a total effective focal length f of the optical imaging camera lens assembly is 8.41 mm, TTL is a total length of the optical imaging camera lens assembly, TTL is 31.00 mm, ImgH is a half of a diagonal length of an effective pixel region on the imaging surface S17 of the optical imaging camera lens assembly, ImgH is 4.21 mm, and FOV is a maximum field of view of the optical imaging camera lens assembly, FOV is 57.8°.

Table 7 shows a basic parameter table of the optical imaging camera lens assembly in Embodiment 4, wherein the units of curvature radius, thickness/distance and focal length are all millimeters (mm). Table 8 shows high-order coefficients that can be applied to various aspheric lens surfaces in Embodiment 4, wherein the aspheric surface shapes can be defined by the formula (1) given in the above Embodiment 1.

TABLE 7

| Surface | Surface | Curvature | Thickness/ | Refractive | Abbe | | Focal | Conic |
|---|---|---|---|---|---|---|---|---|
| number | type | radius | distance | index | number | Material | length | coefficient |
| OBJ | Spherical | Infinite | Infinite | | | | | |
| S1 | Aspheric | 5.4837 | 1.7000 | 1.55 | 56.1 | Plastic | −29.21 | −1.0000 |
| S2 | Aspheric | 3.6339 | 5.7882 | | | | | −1.0000 |
| S3 | Aspheric | −10.6308 | 3.1817 | 1.58 | 40.9 | Glass | 25.46 | 0.0000 |
| S4 | Aspheric | −6.8834 | 0.1018 | | | | | 0.0000 |
| STO | Spherical | Infinite | 0.0300 | | | | | |
| S5 | Aspheric | 46.5748 | 3.1795 | 1.54 | 55.7 | Plastic | 44.78 | −34.7216 |
| S6 | Aspheric | −48.4803 | 0.0300 | | | | | 49.8240 |
| S7 | Aspheric | 9.7909 | 1.9000 | 1.66 | 20.4 | Plastic | −17.16 | 0.0978 |
| S8 | Aspheric | 4.8639 | 0.7396 | | | | | −0.9242 |
| S9 | Aspheric | 20.9719 | 3.8222 | 1.55 | 56.1 | Plastic | 10.52 | 0.0000 |
| S10 | Aspheric | −7.9267 | 0.0600 | | | | | 0.0000 |
| S11 | Spherical | 10.5425 | 3.6480 | 1.80 | 46.6 | Glass | 12.36 | |
| S12 | Spherical | −156.8579 | 0.0300 | | | | | |
| S13 | Aspheric | 186.6232 | 1.8607 | 1.67 | 19.2 | Plastic | −11.50 | 0.0000 |
| S14 | Aspheric | 7.4519 | 1.2081 | | | | | 0.0000 |
| S15 | Spherical | Infinite | 0.7000 | 1.52 | 64.2 | Glass | | |
| S16 | Spherical | Infinite | 3.0209 | | | | | |
| S17 | Spherical | Infinite | | | | | | |

TABLE 8

| Surface | | | | | | | | | |
|---|---|---|---|---|---|---|---|---|---|
| number | A4 | A6 | A8 | A10 | A12 | A14 | A16 | A18 | A20 |
| S1 | −5.6889E−04 | −1.4141E−05 | −8.4432E−07 | 6.1166E−08 | −1.3202E−09 | 1.1944E−11 | 3.8922E−15 | −5.4098E−16 | 0.0000E−00 |
| S2 | −2.2903E−04 | −6.2647E−05 | 3.8438E−06 | −4.1939E−07 | 2.8712E−08 | −9.1987E−10 | 1.1593E−11 | 0.0000E−00 | 0.0000E−00 |
| S3 | 1.6050E−05 | 3.8858E−06 | −2.2062E−06 | 3.8802E−08 | −1.16680E−09 | 7.1747E−111 | −3.6863E−12 | 8.8652E−14 | 0.0000E−00 |
| S4 | 1.1484E−03 | −4.5105E−05 | 1.4311E−06 | −5.0907E−08 | 7.7757E−10 | 6.5921E−11 | −4.2679E−12 | 1.1758E−13 | −1.7092E−15 |
| S5 | 9.3712E−04 | −8.0882E−05 | 3.3767E−06 | −1.5441E−07 | 6.1741E−09 | −1.3077E−10 | 1.0482E−12 | 0.0000E−00 | 0.0000E−00 |
| S6 | 5.6313E−04 | 8.2693E−07 | −4.8206E−06 | 2.4558E−07 | −4.4939E−09 | 2.0450E−11 | 1.5883E−13 | 0.0000E−00 | 0.0000E−00 |
| S7 | −3.0635E−03 | 1.6110E−04 | −6.4001E−06 | 3.9822E−08 | 8.5549E−09 | −3.4380E−10 | 5.4893E−12 | −3.2574E−14 | 0.0000E−00 |
| S8 | −5.6444E−03 | 3.4570E−04 | −1.6645E−05 | 5.9665E−07 | −1.6591E−08 | 3.4941E−10 | −4.5775E−12 | 2.6262E−14 | 0.0000E−00 |
| S9 | 2.7076E−04 | −4.2067E−05 | 4.7861E−06 | −2.8556E−07 | 8.6098E−09 | −1.1772E−10 | 4.7399E−13 | 1.6412E−15 | 0.0000E−00 |
| S10 | 1.1996E−03 | −2.7322E−05 | 8.5899E−07 | −2.9068E−08 | 9.7938E−10 | −1.5201E−11 | 4.2387E−14 | 6.3761E−16 | 0.0000E−00 |
| S13 | 6.5285E−04 | −9.5233E−05 | 6.8784E−06 | −2.5070E−07 | 4.9084E−09 | −5.2092E−11 | 2.8194E−13 | 0.0000E−00 | 0.0000E−00 |
| S14 | −1.1576E−04 | −3.0949E−05 | 9.8102E−06 | −7.4577E−07 | 4.6500E−08 | −8.1675E−10 | −6.2553E−11 | 2.5578E−12 | 0.0000E−00 |

FIG. 8A shows a longitudinal aberration curve of the optical imaging camera lens assembly in Embodiment 4, which is the deviation of focus points of light with different wavelengths after passing through the camera lens. FIG. 8B shows an astigmatism curve of the optical imaging camera lens assembly in Embodiment 4, which is the curvature of a meridional image surface and the curvature of a sagittal image surface. FIG. 8C shows a distortion curve of the optical imaging camera lens assembly in Embodiment 4, which is distortion size values corresponding to different image heights. FIG. 8D shows a lateral color curve of the optical imaging camera lens assembly in Embodiment 4, which is the deviation of different image heights on the imaging plane after the light passes through the camera lens. It can be seen according to FIG. 8A to FIG. 8D that, the optical imaging camera lens assembly provided in Embodiment 4 can realize good imaging quality.

### Embodiment 5

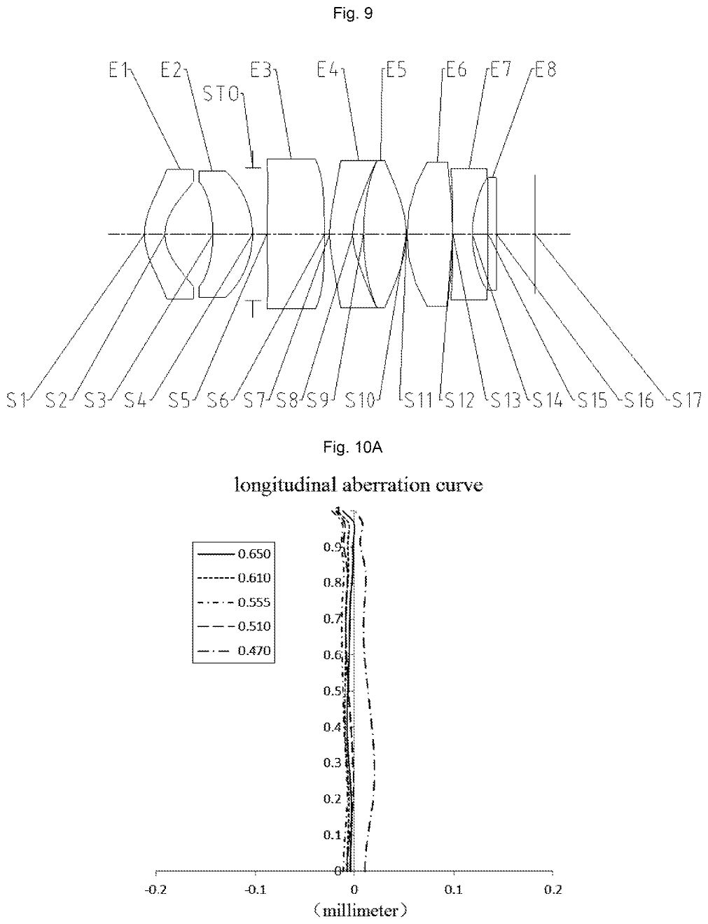

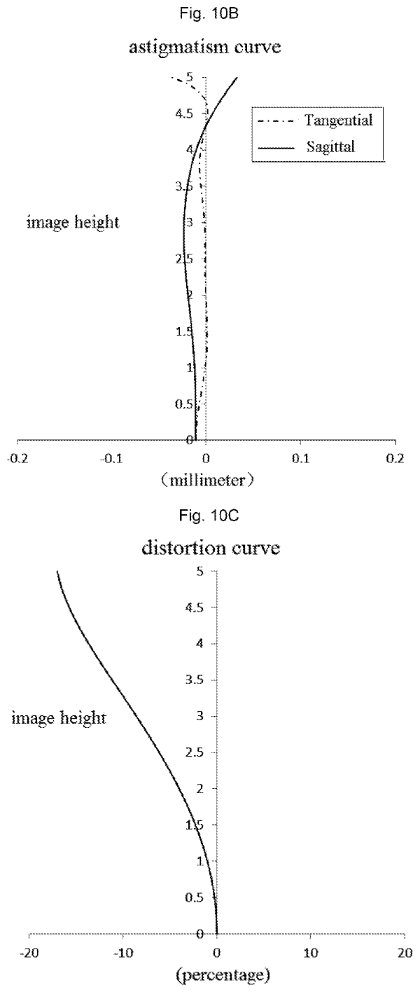

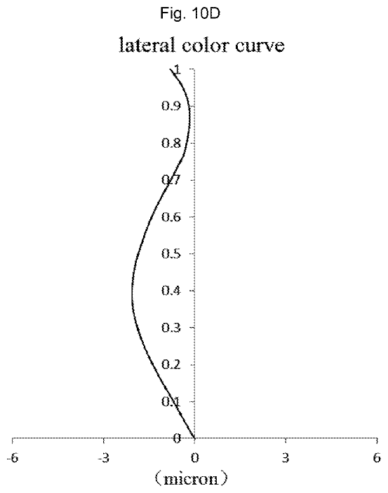

An optical imaging camera lens assembly according to Embodiment 5 of the disclosure will be described below with reference to FIG. 9 to FIG. 10D. FIG. 9 shows a schematic structural diagram of the optical imaging camera lens assembly according to Embodiment 5 of the disclosure.

As shown in FIG. 9, the optical imaging camera lens assembly sequentially includes, from an object side to an image side: a first lens E1, a second lens E2, a diaphragm ST0, a third lens E3, a fourth lens E4, a fifth lens E5, a sixth lens E6, a seventh lens E7, an optical filter E8 and an imaging surface S17.

The first lens E1 has a negative refractive power, an object-side surface S1 of which is a convex surface, and an image-side surface S2 of which is a concave surface. The second lens E2 has a positive refractive power, the object-side surface S3 of which is a concave surface, and the image-side surface S4 of which is a convex surface. The third lens E3 has a positive refractive power, the object-side surface S5 of which is a convex surface, and the image-side surface S6 of which is a convex surface. The fourth lens E4 has a negative refractive power, the object-side surface S7 of which is a convex surface, and the image-side surface S8 of which is a concave surface. The fifth lens E5 has a positive refractive power, the object-side surface S9 of which is a convex surface, and the image-side surface S10 of which is a convex surface. The sixth lens E6 has a positive refractive power, the object-side surface S11 of which is a convex surface, and the image-side surface S12 of which is a convex surface. The seventh lens E7 has a negative refractive power, the object-side surface S13 of which is a convex surface, and the image-side surface S14 of which is a concave surface. The optical filter E8 has an object-side surface S15 and an image-side surface S16. The light from an object sequentially passes through the surfaces S1 to S16 and is finally imaged on the imaging surface S17.

In the present example, a total effective focal length f of the optical imaging camera lens assembly is 8.54 mm, TTL is a total length of the optical imaging camera lens assembly, TTL is 32.49 mm, ImgH is a half of a diagonal length of an effective pixel region on the imaging surface S17 of the optical imaging camera lens assembly, ImgH is 5.00 mm, and FOV is a maximum field of view of the optical imaging camera lens assembly, FOV is 70.4°.

Table 9 shows a basic parameter table of the optical imaging camera lens assembly in Embodiment 5, wherein the units of curvature radius, thickness/distance and focal length are all millimeters (mm). Table 10 shows high-order coefficients that can be applied to various aspheric lens surfaces in Embodiment 5, wherein the aspheric surface shapes can be defined by the formula (1) given in the above Embodiment 1.

TABLE 9

| Surface | Surface | Curvature | Thickness/ | Refractive | Abbe | | Focal | Conic |
|---|---|---|---|---|---|---|---|---|
| number | type | radius | distance | index | number | Material | length | coefficient |
| OBJ | Spherical | Infinite | Infinite | | | | | |
| S1 | Aspheric | 5.1505 | 1.7000 | 1.55 | 56.1 | Plastic | −25.63 | −1.0000 |
| S2 | Aspheric | 3.3258 | 3.9878 | | | | | −1.0000 |
| S3 | Aspheric | −10.3008 | 3.3000 | 1.55 | 20.4 | Plastic | 26.20 | 0.0000 |
| S4 | Aspheric | −6.6662 | 0.0300 | | | | | 0.0000 |
| STO | Spherical | Infinite | 1.1519 | | | | | |
| S5 | Aspheric | 98.4715 | 4.8000 | 1.54 | 56.1 | Plastic | 61.18 | −99.0000 |
| S6 | Aspheric | −48.4256 | 0.4322 | | | | | 43.4543 |
| S7 | Aspheric | 9.3538 | 1.9296 | 1.66 | 20.4 | Plastic | −18.67 | 0.1160 |
| S8 | Aspheric | 4.8975 | 0.8763 | | | | | −0.8971 |
| S9 | Aspheric | 17.6818 | 3.5545 | 1.55 | 55.7 | Plastic | 10.45 | 0.0000 |
| S10 | Aspheric | −7.8246 | 0.0600 | | | | | 0.0000 |
| S11 | Spherical | 11.6277 | 3.8020 | 1.80 | 60.4 | Glass | 11.61 | |
| S12 | Spherical | −41.1496 | 0.0300 | | | | | |
| S13 | Aspheric | 314.8077 | 1.6000 | 1.66 | 19.2 | Plastic | −12.09 | 0.0000 |
| S14 | Aspheric | 7.8339 | 1.3232 | | | | | 0.0000 |
| S15 | Spherical | Infinite | 0.7000 | 1.52 | 64.2 | Glass | | |
| S16 | Spherical | Infinite | 3.2111 | | | | | |
| S17 | Spherical | Infinite | | | | | | |

TABLE 10

| Surface | | | | | | | | | |
|---|---|---|---|---|---|---|---|---|---|
| number | A4 | A6 | A8 | A10 | A12 | A14 | A16 | A18 | A20 |
| S1 | −7.1686E−04 | −3.3935E−05 | −4.3544E−07 | 8.6613E−08 | −2.4962E−09 | 2.8704E−11 | 1.9142E−14 | −2.2289E−15 | 0.0000E−00 |
| S2 | −3.7897E−04 | −8.4517E−05 | 5.9287E−07 | 1.3014E−07 | −3.9694E−09 | −8.3054E−12 | 1.5755E−12 | 0.0000E−00 | 0.0000E−00 |
| S3 | 4.8688E−04 | −2.7290E−05 | −2.7046E−06 | 2.2719E−07 | −1.4003E−08 | 3.4774E−10 | −1.1651E−12 | −1.0644E−14 | 0.0000E−00 |
| S4 | 1.6596E−03 | −1.3042E−04 | 6.9456E−06 | −2.6385E−07 | 5.8950E−09 | −4.8717E−11 | −3.3109E−13 | 1.3914E−14 | −2.2320E−16 |
| S5 | 1.3776E−03 | −1.7274E−04 | 1.1015E−05 | −5.3022E−07 | 1.7270E−08 | −3.1082E−10 | 2.2708E−13 | 0.0000E−00 | 0.0000E−00 |
| S6 | 2.5519E−04 | 1.4110E−05 | −3.1621E−06 | 1.2741E−07 | −1.8679E−09 | 2.7373E−12 | 1.0755E−13 | 0.0000E−00 | 0.0000E−00 |
| S7 | −2.7291E−03 | 1.5462E−04 | −6.2717E−06 | 8.8113E−08 | 2.7585E−09 | −1.3150E−10 | 1.9744E−12 | −1.0583E−14 | 0.0000E−00 |
| S8 | −4.6559E−03 | 2.6200E−04 | −1.1238E−05 | 3.3035E−07 | −6.9279E−09 | 1.1010E−10 | −1.1979E−12 | 6.1824E−15 | 0.0000E−00 |
| S9 | −2.3907E−04 | −1.0606E−05 | 3.0960E−06 | −1.8577E−07 | 5.0124E−09 | −6.0291E−11 | 2.1186E−13 | 6.8839E−16 | 0.0000E−00 |
| S10 | 8.2221E−04 | −5.9665E−06 | 4.6285E−07 | −1.9970E−08 | 4.7352E−10 | −3.7931E−12 | −1.7121E−14 | 3.1584E−16 | 0.0000E−00 |
| S13 | −9.3375E−04 | 5.4688E−05 | −2.5672E−06 | 9.8105E−08 | −2.2933E−09 | 2.7040E−11 | −1.1660E−13 | 0.0000E−00 | 0.0000E−00 |
| S14 | −2.2736E−03 | 1.1139E−04 | −2.3925E−06 | −9.5695E−08 | 1.3266E−08 | −4.1253E−10 | 1.2693E−12 | 1.1541E−13 | 0.0000E−00 |

FIG. 10A shows a longitudinal aberration curve of the optical imaging camera lens assembly in Embodiment 5, which is the deviation of focus points of light with different wavelengths after passing through the camera lens. FIG. 10B shows an astigmatism curve of the optical imaging camera lens assembly in Embodiment 5, which is the curvature of a meridional image surface and the curvature of a sagittal image surface. FIG. 10C shows a distortion curve of the optical imaging camera lens assembly in Embodiment 5, which is distortion size values corresponding to different image heights. FIG. 10D shows a lateral color curve of the optical imaging camera lens assembly in Embodiment 5, which is the deviation of different image heights on the imaging plane after the light passes through the camera lens. It can be seen according to FIG. 10A to FIG. 10D that, the optical imaging camera lens assembly provided in Embodiment 5 can realize good imaging quality.

In summary, Embodiment 1 to Embodiment 5 satisfy relationships shown in Table 11 respectively.

TABLE 11

| Conditional formula/embodiment | 1 | 2 | 3 | 4 | 5 |
|---|---|---|---|---|---|
| f/EPD | 0.95 | 1.05 | 1.05 | 0.94 | 0.95 |
| TTL/f | 3.79 | 3.62 | 3.57 | 3.68 | 3.80 |
| f1/f | −2.40 | −2.85 | −2.85 | −3.47 | −3.00 |
| f4/7 | 0.57 | 1.32 | 1.43 | 1.49 | 1.54 |
| (f5 + f6)/f3 | 2.23 | 0.43 | 0.55 | 0.52 | 0.36 |
| (R1 + R2)/(R3 + R4) | −0.57 | −0.45 | −0.47 | −0.52 | −0.50 |
| R7/R8 | 2.69 | 2.02 | 2.01 | 2.01 | 1.91 |
| (R9 + R10)/(R9 − R10) | 0.22 | 0.40 | 0.37 | 0.45 | 0.39 |
| ΣCT/ΣAT | 4.04 | 3.08 | 3.02 | 2.85 | 3.15 |
| SL/(CT3 + CT4 + CT5 + CT6 + CT7) | 1.38 | 1.55 | 1.50 | 1.40 | 1.50 |
| f67/(R11 + R14) | 1.16 | 2.26 | 4.36 | 3.52 | 2.25 |
| T12/(SAG11 + SAG12) | 0.91 | 0.97 | 1.11 | 1.21 | 0.95 |
| CT2/(SAG21 − SAG22) | 5.83 | 3.68 | 3.60 | 3.40 | 3.03 |
| (ET4 + ET5)/(ET6 + ET7) | 1.18 | 0.96 | 0.99 | 0.82 | 0.76 |

The disclosure further provides an imaging apparatus, wherein an electronic photosensitive element of which can be a photosensitive coupling element (CCD) or a complementary metal oxide semiconductor device (CMOS). The imaging apparatus can be an independent imaging device such as a digital camera, or an imaging module integrated on a mobile electronic device such as a mobile phone. The imaging apparatus is equipped with the optical imaging camera lens assembly described above.

The foregoing descriptions are only preferred embodiments of the disclosure and illustrations of technical principles used. Those skilled in the art should understand that, the scope of invention involved in the disclosure is not limited to the technical solutions formed by specific combinations of the above technical features, but also covers other technical solutions formed by any combination of the above technical features or their equivalents, without departing from the inventive concept, for example, a technical solution formed by replacing the above features with the technical features disclosed in the disclosure (but not limited to) having similar functions.

What is claimed is:

1. An optical imaging camera lens assembly, sequentially comprising, from an object side to an image side along an optical axis:
a first lens having a refractive power;
a second lens having a positive refractive power;
a third lens having a refractive power;
a fourth lens having a negative refractive power;
a fifth lens having a positive refractive power;
a sixth lens having a refractive power; and
a seventh lens having a refractive power;
at least four lenses among the first lens to the fifth lens are lenses made of a plastic material;
the sixth lens is a spherical lens made of a glass material; and
a total effective focal length f of the optical imaging camera lens assembly and an entrance pupil diameter (EPD) of the optical imaging camera lens assembly satisfy: f/EPD<1.2.

2. The optical imaging camera lens assembly according to claim 1, wherein an effective focal length f1 of the first lens and the total effective focal length f of the optical imaging camera lens assembly satisfy: −3.6<f1/f<−2.2.

3. The optical imaging camera lens assembly according to claim 1, wherein the effective focal length f4 of the fourth lens and the effective focal length f7 of the seventh lens satisfy: 0.4<f4/f7<1.7.

4. The optical imaging camera lens assembly according to claim 1, wherein the effective focal length f3 of the third lens, the effective focal length f5 of the fifth lens and the effective focal length f6 of the sixth lens satisfy: 0.2<(f5+f6)/f3<2.4.

5. The optical imaging camera lens assembly according to claim 1, wherein a curvature radius R1 of an object-side surface of the first lens, the curvature radius R2 of an image-side surface of the first lens, the curvature radius R3 of an object-side surface of the second lens and the curvature radius R4 of an image-side surface of the second lens satisfy: −0.7<(R1+R2)/(R3+R4)<−0.3.

6. The optical imaging camera lens assembly according to claim 1, wherein the curvature radius R7 of an object-side surface of the fourth lens and the curvature radius R8 of an image-side surface of the fourth lens satisfy: 1.7<R7/R8<2.8.

7. The optical imaging camera lens assembly according to claim 1, wherein the curvature radius R9 of an object-side surface of the fifth lens and the curvature radius R10 of an image-side surface of the fifth lens satisfy: 0<(R9+R10)/(R9−R10)<0.6.

8. The optical imaging camera lens assembly according to claim 1, wherein a combined focal length f67 of the sixth lens and the seventh lens, the curvature radius R11 of an object-side surface of the sixth lens, and the curvature radius R14 of an image-side surface of the seventh lens satisfy: 1.0<f67/(R11+R14)<4.5.

9. The optical imaging camera lens assembly according to claim 1, wherein a spacing distance T12 on the optical axis between the first lens and the second lens, a distance SAG11 on the optical axis from an intersection point of an object-side surface of the first lens and the optical axis to an effective radius vertex of the object-side surface of the first lens, and a distance SAG12 on the optical axis from the intersection point of an image-side surface of the first lens and the optical axis to the effective radius vertex of the image-side surface of the first lens satisfy: 0.8<T12/(SAG11+SAG12)<1.4.

10. The optical imaging camera lens assembly according to claim 1, wherein a center thickness CT2 of the second lens on the optical axis, a distance SAG21 on the optical axis from the intersection point of an object-side surface of the second lens and the optical axis to the effective radius vertex of the object-side surface of the second lens, and a distance SAG22 on the optical axis from the intersection point of an image-side surface of the second lens and the optical axis to the effective radius vertex of the image-side surface of the second lens satisfy: 2.9<CT2/(SAG21−SAG22)<6.0.

11. The optical imaging camera lens assembly according to claim 1, wherein an edge thickness ET4 of the fourth lens, an edge thickness ET5 of the fifth lens, an edge thickness ET6 of the sixth lens and an edge thickness ET7 of the seventh lens satisfy: 0.5<(ET4+ET5)/(ET6+ET7)<1.3.

12. The optical imaging camera lens assembly according to claim 1, wherein TTL is a distance on the optical axis from an object-side surface of the first lens to an imaging surface of the optical imaging camera lens assembly, and the total effective focal length f of the optical imaging camera lens assembly and TTL satisfy: 2.0<TTL/f<4.0.

13. The optical imaging camera lens assembly according to claim 1, wherein a sum ΣCT of a center thicknesses of the first lens to the seventh lens on the optical axis, and a sum ΣAT of a spacing distances on the optical axis of any two adjacent lenses among the first lens to the seventh lens satisfy: 2.6<ΣCT/ΣAT<4.2.

14. The optical imaging camera lens assembly according to claim 1, wherein the optical imaging camera lens assembly further comprises a diaphragm, a distance SL on the optical axis from the diaphragm to the imaging surface of the optical imaging camera lens assembly, a center thickness CT3 of the third lens on the optical axis, a center thickness CT4 of the fourth lens on the optical axis, a center thickness CT5 of the fifth lens on the optical axis, a center thickness CT6 of the sixth lens on the optical axis, and a center thickness CT7 of the seventh lens on the optical axis satisfy: 1.2<SL/(CT3+CT4+CT5+CT6+CT7)<1.7.15. An optical imaging camera lens assembly, sequentially comprising, from an object side to an image side along an optical axis:
a first lens having a refractive power;
a second lens having a positive refractive power;
a third lens having a refractive power;
a fourth lens having a negative refractive power;
a fifth lens having a positive refractive power;
a sixth lens having a refractive power; and
a seventh lens having a refractive power;
at least four lenses among the first lens to the fifth lens are lenses made of a plastic material;
the sixth lens is a spherical lens made of a glass material; and
a combined focal length f67 of the sixth lens and the seventh lens, a curvature radius R11 of an object-side surface of the sixth lens, and a curvature radius R14 of an image-side surface of the seventh lens satisfy: 1.0<f67/(R11+R14)<4.5
